(19) United States
(12) Patent Application Publication
(10) Pub. No.: US 2009/0194035 A1
(43) Pub. Date: Aug. 6, 2009

(54) Pet stabilizing platform for motor vehicle interiors

(76) Inventors: Charles Ethan Albert Cody, Hamilton, NJ (US); Charles Alber Cody, Nashville, IN (US)

Correspondence Address: Charles A. Cody, 3247 Polecat Ridge RD, Nashville, IN, 47448, US

(21) Appl. No.: 12/321,932

(22) Filed: Jan. 28, 2009

Related U.S. Application Data
(63) Continuation of application No. 11/478,597, filed on Jul. 3, 2006.

(51) Int. Cl. A01K 29/00; A01K 1/035

(52) U.S. Cl. 119/702

(57) ABSTRACT

A device is described that provides a stabilizing platform for a domestic pet animal that contributes to the safety of the animal when it occupies the interior of a motor vehicle. The stabilizing platform can be placed on the interior side wall panel which contains a window in a motor vehicle, thereby allowing the pet to place its feet on the top surface of the platform so that the pet can look out the window or place its head out a partially opened window while increasing the pet's stability and safety. Furthermore, the use of the stabilizing platform aids in the safety and comfort of the motorist and passengers.

This application is a continuation of U.S. patent application Ser. No. 11/478,597 filed Jul. 3, 2007; this entire disclosure is hereby incorporated by reference into the present disclosure. The present invention relates to a tray and, more particularly, to a pet stabilizing platform that is mounted on the interior side panel of the motor vehicle which contains a window.

### FIELD OF THE INVENTION

### Background of the Invention

The number of mammalian household pets worldwide continues to grow. In the United States alone, the current number of dogs and cats is estimated to exceed 60 million. Recently, products in the form of car seats, carriers, and harnesses have been developed for use by motorists to assist with the transport of household pets in the passenger cabins of motor vehicles such as automobiles, trucks, vans, commercial vehicles and sports utility vehicles. These items contribute to the safety, containment and stability of household pets while concurrently increasing the safety of the motorist and passengers in motor vehicles.

It is well known that dogs and cats and other mammalian household pets, when placed in an automobile, truck or motor vehicle cabin equipped with side windows, and even a vertical back window that can be opened and is equipped with a ledge, will tend to look out of the windows, and, when the window is open, place their heads, and even the front part of their bodies, out of the window, external to the motor vehicle. In either case, during the act of looking out the closed window or placing their heads out of the open windows, pets tend to place their feet on the shelf or ridge at the base of the window, or window sill, on the interior side of the vehicle. In particular, the household pet will place their feet, as in the case of four-legged pets, front feet, on the sill located adjacent to the bottom of the interior side of a window and also on the side interior wall panel located vertically below the glass window. For example, a dog, in the act of placing its head out the window with its front feet placed on the window sill, presents numerous problems that are addressed and resolved by the present invention.

One problem that occurs from the act of the pet repeatedly climbing on the interior window sill located on the side interior wall panel is that the material covering the interior door can be dirtied from the feet of the animal, or damaged and torn from the claws located in the animal's feet. A second problem is that, when the window is closed, there is simply not enough room for the pet's feet to be placed on the sill at the base of the window to steady itself. A third problem occurs which raises a safety concern. The motor vehicle occupants may fully open the window to give the pet a wider base to place its feet providing an opportunity wherein the pet can then potentially propel itself out the car through the fully opened window thereby injuring itself upon landing, or causing the accident of a near-by second vehicle swerving to miss the pet, or, in another instance, propelling itself onto a person or another animal located externally to the motor vehicle.

A fourth issue involves the safety of the pet when occupying the passenger compartment of a motor vehicle. Due to movements of the vehicle such as sudden changes in speed, abrupt turning motions, up and down gyrations due to pot holes and rough road surfaces and so forth, the pet can readily lose its balance and fall, possibly injuring itself or even passengers. This lack of a stable resting area for a pet's paws on the side interior wall panel presents a real safety concern since the motorist can be distracted resulting in a serious motor vehicle accident.

Consequently, there arises a serious need to enhance the safety, containment and stability of pets and the safety and comfort of passengers and motorists occupying motor vehicles and the present invention resolves these problems.

### SUMMARY OF THE INVENTION

The present invention provides for a removable platform that can be anchored to a location in a motor vehicle interior to provide a stable site for pets to place their feet while looking out the vehicle cabin window. The device will herein be referred to as a pet stabilizing platform or platform. The platform comprises a tray held in place by a means of attachment that anchors the platform to the interior side wall panel on the interior side of a motor vehicle. Legs that are attached to the bottom side or underside of the tray are used to stabilize the platform against the interior window sill, the side wall door panels, and/or arm rests on the interior side panel of the motor vehicle where windows are located. The platform, when placed in a motor vehicle, provides a stable horizontal surface separate from the actual window sill for the pet to rest its feet while looking out a window and, secondly, keeps the animal's feet from coming in contact with the interior material on the window sill, the arm rest located on the interior side wall panel, and the vehicle interior side wall panels.

The safety issue involving a pet losing its balance inside the passenger compartment of a motor vehicle is greatly lessened by the use of the platform. In particular, the tray of the platform can be anchored on the interior side wall of a motor vehicle, and, when the window is either partially opened or in a closed position, the possible external exit of the pet from the motor vehicle is thereby inhibited. Furthermore, it is also desired that the platform have the ability to be positioned long-term in the interior of the motor vehicle, yet be easily removable. The easily removable option provides additional space for the motorist and passengers in the vehicle cabin when the pet is not present and allows the motorist/operator to easily relocate the platform to other vehicles.

As a consequence, owners and operators of motor vehicles now have a device that provides a stable platform that provides a safe, convenient and secure mechanism for the pet to look out the motor vehicle compartment window.

### BRIEF DESCRIPTION OF THE FIGURES

FIG. 1 is a perspective view of an illustrative embodiment of a pet stabilizing platform in accordance with the present invention.

FIG. 2 is an enlarged perspective view of the exterior edge of the tray part of the pet stabilizing platform shown in FIG. 1, illustrating a means for attaching the platform to the window sill.

FIG. 3 is an enlarged perspective view of the exterior edge of the tray part of the pet stabilizing platform shown in FIG. 1, illustrating an alternate means of attaching the platform to the window sill.

FIG. 4 is a perspective view of the attachment of the pet stabilizing platform shown in FIG. 1, showing the placement of the strap attachment to the window seal gasket located between the motor vehicle door and the window pane located in the door.

FIG. 5 is a partial perspective view of the tray attached to the window where the tray contains a linear trough on the underside of the tray of the platform attached to the top of the window pane.

FIG. 6 is an enlarged view of the means for extending by which the supporting legs of the pet stabilizing platform in FIG. 1 are adjustable in length.

FIG. 7 is an enlarged view of the means for extending by which the supporting legs of the pet stabilizing platform shown in FIG. 1 are adjustable in length.

FIG. 8 is a perspective view of the pet stabilizing platform of FIG. 1 shown mounted to the side window and interior side wall panel of an automobile passenger compartment.

### DETAILED DESCRIPTION OF THE INVENTION

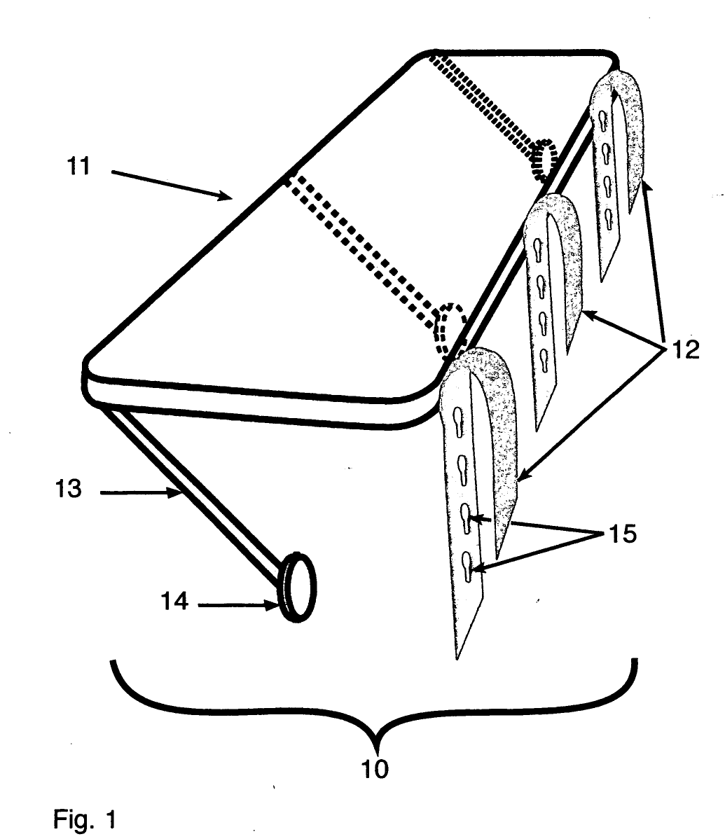

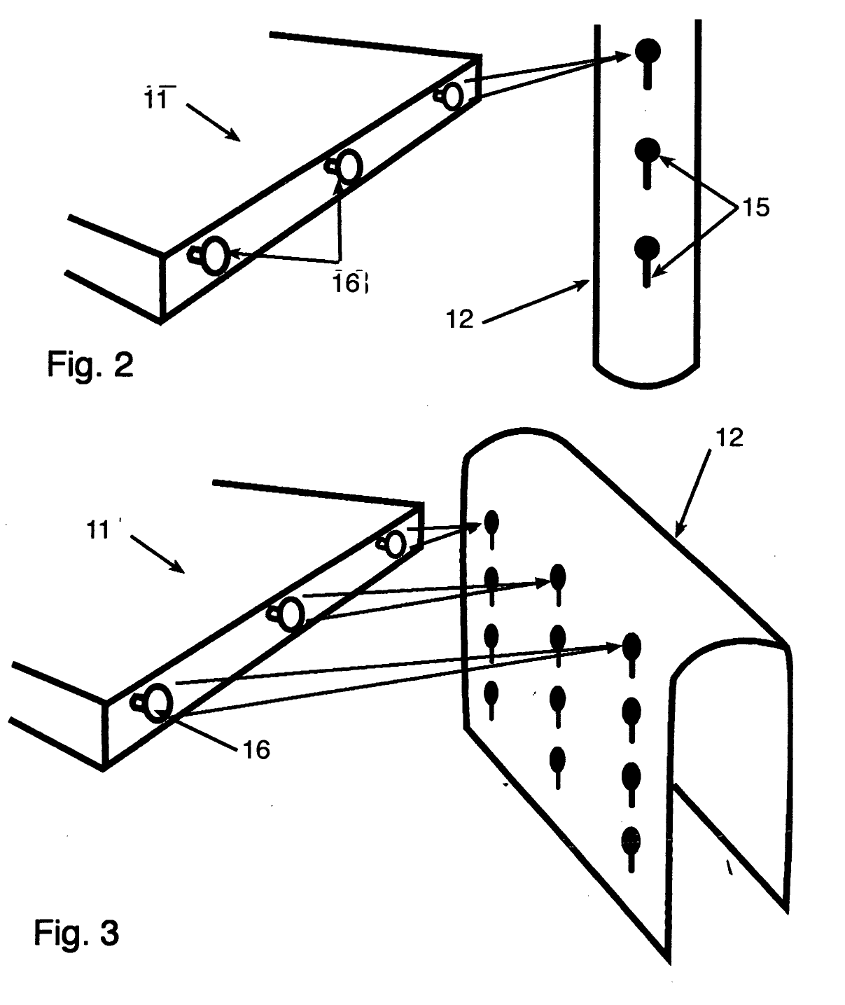

The embodiments shown in FIG. 1 exemplify certain features of the pet stabilizing platform. The invention will now be described in connection with preferred embodiments. These embodiments are presented to aid in an understanding of the present invention and are not intended to, and should not be construed to limit the invention in any way. All alternatives, modifications and equivalents that may become obvious to those of ordinary skill when reading the disclosure are included within the spirit and scope of the present invention.

The term pet is used to designate a mammal which is tamed or domesticated and reared in a household and/or yard environment for affection, companionship, enjoyment and entertainment of the personnel occupying the household. Some of the more common examples include dogs, cats, and pigs.

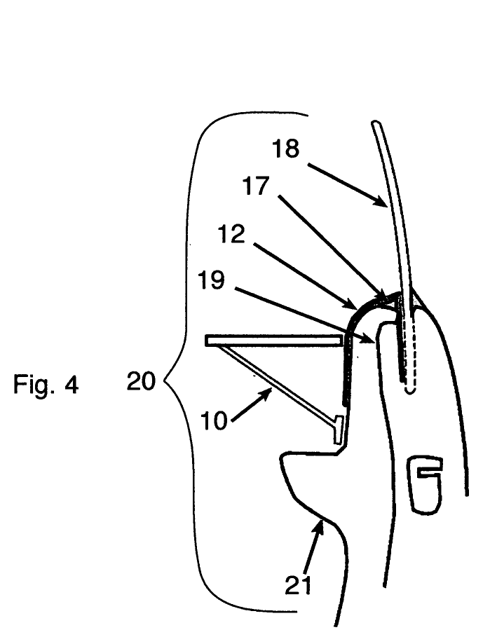

The present invention provides a pet stabilizing platform device as illustrated in FIG. 1. The pet stabilizing platform 10 comprises a rigid tray 11 to which at least one leg 13 is attached to stabilize the movement of the tray against the interior side wall panel of the vehicle and a means of attaching the tray and leg assembly tray to the interior side wall which is depicted as a strap 12. An interior side wall engaging foot assembly 14 is provided for supporting the tray leg on the interior side panel. The pet stabilizing platform is attached to the interior side of a motor vehicle window sill 19 and interior side wall panel 20 as is illustrated in FIG. 4.

The pet stabilizing platform is anchored through an attachment means to the interior side wall panel of the motor vehicle in a position where the pet stabilizing platform leg 13 is engaging the side panel of the motor vehicle wherein the side panel is located adjacent and beneath the window. The term window sill or sill is used to describe the upper portion of the interior motor vehicle wall lying immediately at or below the rubber gasket 17 and the adjacent glass pane 18. The term interior side wall panel or interior side wall is meant to include the interior wall of the motor vehicle compartment located vertically below and adjacent to the interior side of the rear and side windows of a motor vehicle, the interior window sill, the interior side of the window glass, and the arm rest 21, door handle and any other objects permanently attached to the interior wall located below the window. For example, in a four-door sedan, the side panel is the side door of the vehicle and, for a two-door sedan, the side panel would include the interior sides of the two front doors, the rear seat windows and interior wall panels below the windows adjacent to the back seat.

One feature of this invention is the ability to be able to attach the pet stabilizing platform long term to the interior side wall panel of a motor vehicle compartment, yet have it easily removable for storage. This allows the motorist/owner to leave the platform in place for as long as the need arises but then be able to relocate the position of the platform within the vehicle cabin or even move the platform to another motor vehicle when necessary.

The tray 11 is made of solid material and is generally flat. The tray may be in the shape of a rectangle, trapezoid, or, optionally, oval. The tray may, optionally, be concaved upward, concaved downward, or stepped with two or more steps. The edge of the tray located nearest the window is designated as the exterior edge and the edge furthest from the window is called the interior edge. The top surface of the tray is where the pet places its feet or paws.

The tray may be constructed out of any suitable material, including metal, rigid plastic, and wood, and may be sized as required for compatibility with the size and length of the window sill to fit the majority of motor vehicles. For example, the dimensions of the tray are such that the length of the tray is no longer than the width of the window, preferably from about 4 inches up to and including 24 inches in length, from about 2 inches to about 12 inches in width, and from about ⅛ inch up to and including 2 inches in thickness.

The upper or top surface of the tray 11 can be a smooth surface. Preferably the surface should be roughened or textured to allow for good contact and non-slippage between the pet's feet and the top of the tray. The rough surfaces can be in the form of a mottled, wavy, dimpled, ridged, grooved or checkered surface. This can best be achieved by routing or etching the surface of the tray by a means well known in the art. The rough surface can also be achieved by applying a textured coating or paint to the top of the tray, or by attaching a second layer of textured material by adhesives or fastening devices to the top surface of the tray. The attachment of a carpet or fabric material by fasteners to the top of the tray will provide non-slip surfaces.

To the opposite side or bottom side of the tray and in a position that is located near the interior edge of the tray is attached at least one leg 13 by a means well know in the art, said leg is angled such that the opposite end of the leg is fitted with a foot 14 and contacts the interior side wall panel in such a way that the contact provides the maximum amount of foot surface area contact. The leg or legs may be permanently attached to the tray on the vehicle interior side, or hinged or pivotally connected to move at various angles. The legs may be straight, curved or bent in direction.

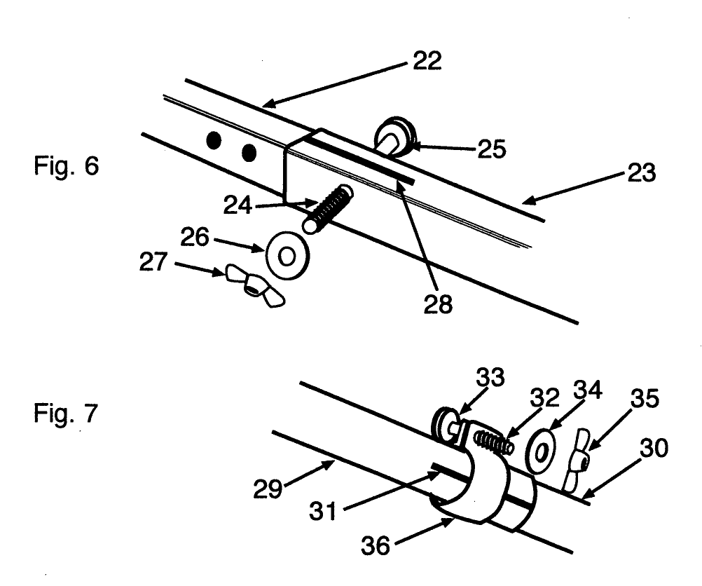

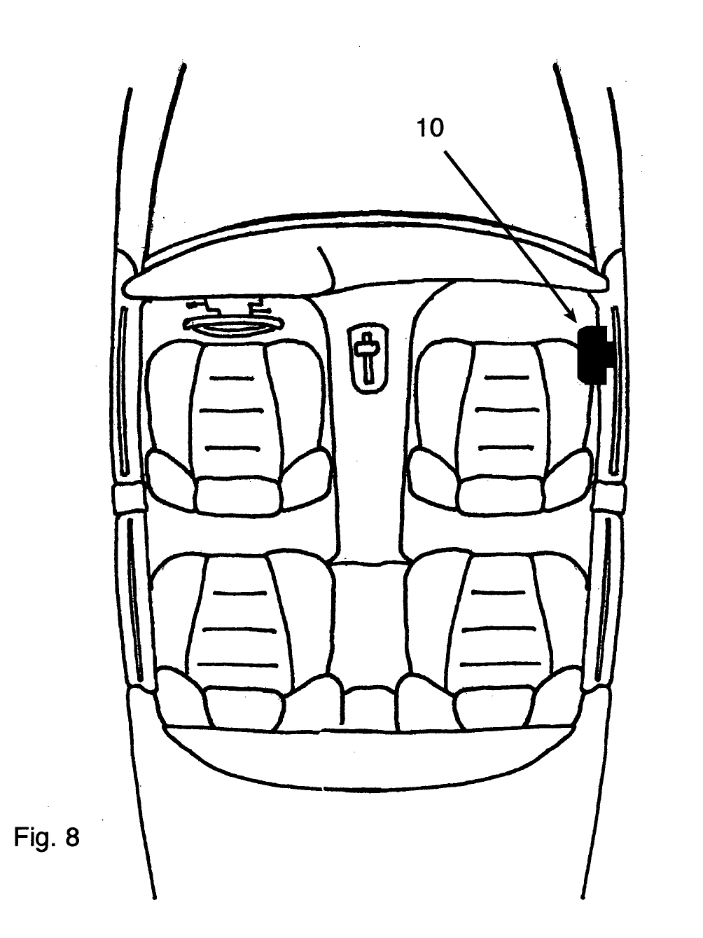

The legs may be of material that is permanently fused together in one solid piece or, preferably, two or more pieces connected together by an adjusting mechanism as exemplary depicted in FIGS. 6 and 7. Furthermore, the hinge or hinges at the attachment of the leg to the opposite surface may include a locking mechanism at the junction of the leg to foot and/or leg to tray so that once the proper leg to tray angle is achieved; the leg position can be locked in place.

The leg or legs may be of any shape in cross section. Some representative examples of the geometric forms include triangular, rectangular, square, oval, circular, and elliptical and polygon forms.

A hinge or hinges at the leg attachment point to the tray allows for the ability to adjust the position of the leg, and correspondingly the platform, to accommodate different widths of interior sills, or for one or more leg or legs to rest atop the arm rest.

The angle between the leg or legs and tray is preferably 30 degrees or larger to enhance stability; higher or lower degrees are acceptable, depending on the relationship between tray width, sill thickness, and the position of the tray on the side wall panel. In the case where the angle between the leg or legs and the tray is approximately 90 degrees, the foot attached to the leg is able to support the platform on the automobile seat.

A preferred embodiment of this invention is a platform that features an adjustable leg length. The adjustable leg length aspect allows the user much more flexibility in positioning the platform, such as, for example, putting one or more legs and feet against the interior side wall panel, yet other legs or leg and foot can contact the arm rest. With an adjustable leg length, the tray and therefore the platform can be readily positioned at any position on the interior side wall panel, below the top of the sill, at or on top of the sill, or even moved and adjusted for placement in another motor vehicle with different interior dimensions. For example, as illustrated in FIG. 6, a rectangular inner leg 22 slides in and out of a larger hollow rectangular outer leg 23 for length adjustment. A bolt 24, washers 25, 26, and wing nut 27 allow for the leg length to be locked in length and a thin slot 28 is present to allow for compression of the outer leg 23 upon locking. In a second example, a larger hollow circular outer leg 29 slides over a smaller circular inner leg 30 for adjustment in length. A thin slot 31 allows compression of the outer leg 29 upon locking. A bolt 32, washers 33, 34, wing nut 35, and ring clamp 36 provide a clamping mechanism so that the leg can be adjusted and then locked in length.

At the opposite end of the leg from the attachment point to the underside of the tray is attached a foot 14 that engages the motor vehicle interior side panel. The foot allows for a larger surface area to contact the sill or arm rest thereby increasing the friction and resulting in increased stability of the platform. The foot can have any shape, such as circular, elliptical, rectangular, and so forth as long as the position of the foot placed adjacent to the interior side wall panel is flat in nature for maximum surface area contact. The flat foot surface, in contact with the interior side wall panel or seat, should have a rough or textured surface. The foot may be permanently attached to the leg, or may be hinged so as to tilt or pivot to provide better contact with the interior side wall panel. Locking hinge mechanisms which are well known in the art are also an option when hinges are used at the leg and foot connection.

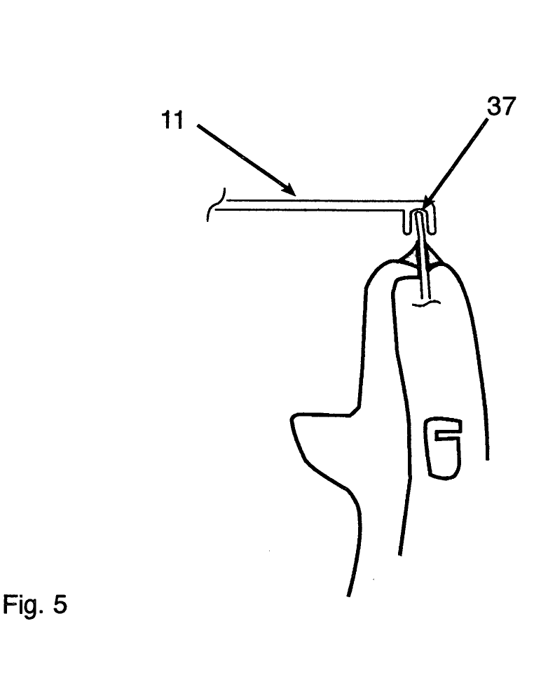

An important feature of this invention is a means of attaching the platform to the interior side wall panel. To the exterior edge of the tray, various types of attaching means can be connected such as suction cups, hooks, clasps, tabs, clamps and straps and other means of attachment that are well known in the art or a combination thereof. A linear trough 37 on the bottom side of the tray 11 which fits directly into the edge of the top of the window pane also provides an example for an attaching means as illustrated in FIG. 5.

The preferred attaching means is a strap made of thin flexible metal, durable woven material, or plastic. The width of the strap is from about ¼ inch to a width that is equal to the length of the tray. The length of the strap is from about 3 inches to 36 inches in length. The end of the strap should be of a thickness so that it readily fits between the interior flexible rubber gasket and the window. In some cases this is achieved by permanently attaching a stiff metal or plastic tab to the flexible strap, especially when the strap is made of a woven material such as textile or plastic. When in place, the strap not only projects below the gasket and window pane but continues across the top of the sill and vertically down.

The strap or straps can be rigid and in the shape of a U or the strap can be flexible so the strap or straps can be bent down over the sill and inserted into the gap between the rubber gasket and window. The exact width, length, thickness and shape of the straps are not critical as long as the strap or straps can be inserted below the gasket window contact point. The strap or straps provide contact with the top of the sill adjacent to the gasket and contact with the interior side of the sill for stability. The strap provides a secure, firm connection and can be readily disassembled and reassembled to aid in being moved within a motor vehicle or moved to another vehicle of the motorist's choice.

As an alternative means for attaching the strap and hence the platform to the interior side wall panel, a suction cup can be permanently attached to the strap wherein the suction cup adheres to the surface of the window pane by vacuum. An additional means for attaching the strap to the window pane involves the permanent attachment of hooks that fit into the gasket cavity or over the top of the window pane glass.

The strap or straps have, along their length, means to connect the strap to the exterior edge of the tray and adjust the position of the tray along the length of the strap. This allows the motorist/operator to adjust up or down the position of the tray to adjust for the size of the pet and the location of the tray on the interior side wall panel. A preferred method of attachment of the strap to the exterior edge of the tray is the placement of a dimple or key 16 attached to the exterior edge of the tray that fits into a slot or key hole 15 located in the strap. The strap contains at least one slot with circular ends or key slots in the strap or straps to allow the dimples or keys attached to the tray to pass through and lock onto the strap at various positions on the strap. This allows for adjustment of the height of the platform at the window sill.

In a manner that obtains a similar result, the keys or dimples can be attached to the strap and the lots or key holes placed into the side of the tray.

Another attachment means includes presence of a trough on the underside of the tray which fits over the edge of the top portion of the window glass pane.

Some optional features that may be attached, either permanently or temporarily to the pet stabilizing platform include a permanently attached or removable guard or fence on the external edge of the tray to keep the pet from using the platform to launch itself out of an open window, one or more cup and drink holders, a compartment underneath the tray to hold maps and or holders of CDs and electronic recording devices.

While the invention has been described in connection with specific embodiments thereof, it will be understood that it is capable of further modifications and this application is intended to cover any variations, uses, or adaptations of the invention following, in general, the principles of the invention and including such departures from the present disclosure as come within known or customary practice within the art to which the invention pertains and as may be applied to the essential features herein before set forth and as follows in the scope of the claims.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. A pet stabilizing platform, upon which a pet animal can place its front feet for stability and support while looking out an automobile window, that is attached to the interior side wall of a motor vehicle adjacent to a window, comprising:
(a) a tray with a length as measured along the automobile window of about 4 inches to 24 inches and width of about 2 inches to 12 inches,
(b) at least one leg attached to the bottom side of the tray and extending to the opposite edge of the tray,
(c) a foot attached to the opposite end of the leg attached to the tray, and
(d) a means for attaching the tray in a horizontal position adjacent to a window in the interior side wall of a motor vehicle, wherein the means of attachment comprises at least one strap attached to the tray by a keyhole and key means wherein an end of the strap is inserted between the window pane and the interior wall adjacent to the window pane.

19. The pet stabilizing platform as in claim 18 wherein the means of attachment comprises at least two straps attached to the tray by a keyhole and key means wherein an end of the strap is inserted between the window pane and the interior wall adjacent to the window pane.

20. A pet stabilizing platform, upon which a pet animal can place its front feet for stability and support while looking out an automobile window, that is attached to the interior side wall of a motor vehicle adjacent to a window, comprising:
(a) a tray with a length as measured along the automobile window of about 4 inches to 24 inches and width of about 2 inches to 12 inches,
(b) at least one leg attached to the bottom side of the tray and extending to the opposite edge of the tray,
(c) a foot attached to the opposite end of the leg attached to the tray, and
(d) a means for attaching the tray in a horizontal position adjacent to a window in the interior side wall of a motor vehicle, wherein the means of attachment comprises at least one strap attached to the tray by a keyhole and key means wherein a tab connected to the strap is inserted between the window pane and the interior wall adjacent to the window pane.

21. The pet stabilizing platform as in claim 20 wherein the means of attachment comprises at least two straps attached to the tray by a keyhole and key means wherein a tab connected to the strap is inserted between the window pane and the interior wall adjacent to the window pane.

22. A pet stabilizing platform, on which a pet animal can place its front feet for stability and support while looking out an automobile window, wherein the platform is attached to the window located adjacent to an interior side wall of a motor vehicle, comprising:
(a) a tray with a length as measured along the automobile window of about 4 inches to 24 inches and width of about 2 inches to 12 inches, wherein the tray has a linear trough on the underside of the tray for attaching the tray to the top edge of a window pane in an automotive vehicle such that the top edge of the window pane fits directly into the linear trough,
(b) at least one leg attached to the bottom side of the tray and extending to the opposite edge of the tray, and
(c) a foot attached to the opposite end of the leg attached to the tray.
